(19) United States
(12) Patent Application Publication
(10) Pub. No.: US 2005/0027551 A1
(43) Pub. Date: Feb. 3, 2005

(54) System and method for enabling self-employed people to work like hired employees in a united company while keeping autonomy and generating additional advantages

(76) Inventors: Yaron Mayer, Jerusalem (IL); Meir Hadad, Jerusalem (IL)

Correspondence Address: YARON MAYER, 21 AHAD HA'AM ST., JERUSALEM, 92151, IL

(21) Appl. No.: 10/822,125

(22) Filed: Apr. 8, 2004

(30) Foreign Application Priority Data
Apr. 11, 2003 (IL) 155388

(51) Int. Cl. G06F 17/60

(52) U.S. Cl. 705/1; 705/4

(57) ABSTRACT

People who are self employed enjoy a larger autonomy than hired employees and can make much more money when successful, however they have also various disadvantages, such as for example having to run books and receipts, having to deal directly with the tax authorities, having to pay an accountant or tax advisor at least once in a while, and not being able to enjoy various benefits of hired employees, such as for example discharge compensations, unemployment payments when the business is down, an upper limit to social security taxes that they might have to pay, or various other tax benefits. Of course self employed people can run their own company and get a salary from the company, however that also has various limitations and still involves similar headaches and expenses. Although a number of companies tried to offer self-employed people the possibility of issuing invoices and receipts for them while they get a salary from the company, such as for example the French Portage companies, few people have joined such ventures, probably because it gives the self-employed person a feeling of loosing control and of being dependent on the company and/or on the actions of other self-employed people who are similarly working through the company. The present invention solves the above problems by enabling self-employed people to work like hired employees in a united company, while still keeping a high level of autonomy without the above described dependency or loss of control, and preferably enjoying also various additional benefits, such as for example getting additional advantages from the organization that joins together self-employed people. This is preferably done by creating a cell structure in the united company so that although each self-employed person is defined in terms of tax status as an employee, he has preferably much more autonomy and is preferably protected from various actions and/or problems of the company and/or of other employees, and preferably the company and other employees are similarly protected from various actions of the self-employed person.

### BACKGROUND OF THE INVENTION

1. Field of the Invention

The present invention relates to employment status, and more specifically to a system and method for enabling self-employed people to work like hired employees in a united company while keeping preferably maximum autonomy and generating additional advantages from the organization that joins together self-employed people.

2. Background

People who are self employed enjoy a larger autonomy than hired employees, however they have also various disadvantages, such as for example having to run books and receipts, having to deal directly with the tax authorities, having to pay an accountant or tax advisor at least once in a while, and not being able to enjoy various benefits of hired employees, such as for example discharge compensations, unemployment payments when the business is down, an upper limit to social security taxes that they might have to pay, or various other tax benefits. On the other hand, hired employees have much less autonomy, and usually get only a salary, or in some cases a salary plus a small percent of the profits of the company (for example by holding stocks or options in the company, or in the form of bonuses or dividends), whereas the self-employed person can make much more money when the business is successful. Of course, a self employed person can also open his own company, but that involves even more headaches and expenses than just being self-employed, such as more complicated book keeping, having to hire an accountant, having to pay for registering and maintaining the company, etc. Also, a person who runs his own company and gets a salary from it is still much more limited for example in the amount of money he can get when quitting, compared to someone who is part of a larger company where he does not have control of the company. Also, various people who are for example basically hired employees but need to work also independently at least part of the time, such as for example lecturers, doctors, consultants, or journalists, many times don't like to open an independent status at the tax authorities, since they like the status of being mostly employees and don't want to have to deal directly with the tax authorities just because they want to be also freelancers part of the time. Although a number of companies tried to offer self-employed people the possibility of issuing invoices and receipts for them while they get a salary from the company, such as for example the French Portage companies, few people have joined such ventures, probably because it gives the self-employed person a feeling of loosing control and of being dependent on the company and/or on the actions of other self-employed people who are similarly working through the company. Clearly, a better alternative would be desirable, where self-employed people can still have as much autonomy as possible, yet enjoy also various benefits of hired employees, and also don't have the headaches of maintaining their own company.

### SUMMARY OF THE INVENTION

The present invention tries to solve the above problems by creating an organization which enables self-employed people to be registered as employees of a large company, yet keep as much autonomy as possible and thus enjoy various benefits without sacrificing almost anything. This is preferably done by creating a cell structure in the company so that although each self-employed person is defined in terms of tax status as an employee, he has preferably much more autonomy and is preferably protected from various actions and/or problems of the company and/or of other employees, and preferably the company and other employees are similarly protected from various actions of the self-employed person. This is preferably accomplished in at least one of the following ways:

1. Preferably the company runs a separate tracking of all the transactions related to each such self-employed employee, for example in a way similar to the individual tracking of the transactions of each insurance agent that works with an insurance company, except that in an insurance company the insurance agents are usually self-employed contractors and are not legally defined as employees of the insurance company. This individual tracking is preferably run by computer, and can be done for example on a monthly basis. In insurance companies this tracking typically comprises tracking all the incoming payments associated with the insurance agent, taking out the part that belongs to the insurance company, transferring any tax advance payments to the tax authorities (these are typically based on the monthly turnover), and transferring the rest to the insurance agent, typically once a month. However, the insurance agent himself has to take care of reports and payments to the VAT authorities (based on the difference between incomes that owe VAT to deductible expenses that include VAT), and the National insurance advance payments (At least in Israel for example this is based on the actual income after expenses and before taxes and is typically updated every year after the yearly tax report to the authorities). However, in the united company the tracking preferably takes into the account also the deductible expenses and therefore also preferably takes care for example of the VAT payments (and/or VAT reports) and National security payments, and preferably prints a periodical (for example monthly) report for the employee that includes preferably both his income and his deductible expenses and preferably sends it to him/her for example electronically and/or by mail. Another possible variation is to apply these additional services for example in an insurance company, so that the insurance agents get additional services from the insurance company and have more free time to concentrate on their sales. Another possible variation is that an insurance company for example also offers its agents the option to become self employed employees in the insurance company, with any of the features described in the present invention, and/or for example the united company can offer such a service also to insurance agents. The first variation has the advantage that since the insurance company already does the minimal necessary individual tracking for the insurance-agent, adding the additional features for insurance agents within the insurance company is more natural. On the other hand, the 2^{nd} variation might be more desirable if for example the insurance agent wishes to work with a number of insurance companies and does not want to feel too dependent on a single insurance company. Anyway, if the self-employed person is officially an employee of the united company, then in addition the company's computer preferably takes care also of filing the appropriate amounts or percentages out of the person's income for required social security arrangements, such as for example discharge compensations funds, advanced study funds, pension funds, and/or other things typically required for hired employees. Preferably for arrangements that are optional and not required by law, the self-employed employee has the choice if he wants to devote a certain amount or percent of his income to that or not. Of course, various combinations of the above and other variations can also be used.

2. Preferably each self-employed employee can personally fill and sign invoices and/or receipts of the united company, without having to depend for example on the company secretary to fill and sign the invoice or receipt for him, except that preferably only the company has a right to issue receipts and/or invoices and determine their serial numbers. Since in the eyes of the tax authorities there is only one united company, obviously all receipts and/or invoices need to conform to or carry the logo and/or identifying details of the company and need to fit with the correct serial numbers, so that preferably different self-employed employees can't get for example the same serial numbers. On the other hand, each receipt preferably has one or more unique identifiers of the self-employed employee, such as for example his full name and/or his ID number and/or an identifier of the field that he is dealing in, so that there is a clear differentiation between invoices or receipts issued by different self-employed employees. This is important in order to give the self-employed employee a feeling of control, autonomy and unique identity of his business, so that he is not just part of an undefined company. Another advantage is that this way the employees are clearly separated from each other, so that if for example one employee cheats his clients or behaves unfairly to them or tries to cheat the tax authorities, or for example does anything else that could cause bad reputation, this does not effect other employees or the company but only the unique “unit” or cell which is identified with him. Of course, various combinations of the above and other variations can also be used.

3. Preferably, unlike in a normal company, each such self-employed employee does not have to make and receive all payments through a common account of the company and wait for example for getting his salary once a month, but instead preferably each such employee can get paid any times he likes during the month (in other words, at any date and any number of times, as long as it is within the maximum allowed amount), and preferably the united company's computer automatically issues a report on the total cumulative monthly salary at or after the end of the month. In addition, preferably each employee has his own bank account, which is preferably an independent sub-unit of the company's account. Each self-employed employee's account can for example be a direct sub-account of the main company's account, or a hierarchy of more than 2 levels can be used, so that for example each account is a sub-division of the unit that identifies the type of business of the self-employed employee, as shown for example in FIG. 2. Preferably the company and the employee have a signed contract with each other and with the bank so that each such employee can deposit and draw his own money from this account like a personal bank account, except that this is preferably regarded as an account of a division of the company that represents the cell associated with that person, and thus this is preferably a business account and not a personal account, and so when the person pulls money out of that account that is not invested back in his commercial activity, this is regarded as drawing his salary. Preferably the contract also ensures that no other employee has access to his account, preferably except for preferably one or more managers of the company who are in charge of monitoring these accounts, and preferably the company can draw money out of the employee's account only under limited conditions, such as for example if he owes the company money for example for required tax advance-payments and/or for other debts and/or obligations. Preferably the company is obligated to the self-employed employees that for example in case it becomes bankrupt it cannot touch these accounts, so that they are defined for example as an entrusted personal fund. The above limitations are extremely important, since otherwise for example employees that make a lot of money and therefore withdraw only a limited salary each month for tax considerations could lose much more than one month's income if the company becomes for example bankrupt for some reason. Another possible variation is that the money is for example in a bank account run by a trustee and for example the trustee has to authorize each extraction of money by the self employed employee from the account. (In this case this can be for example one bank account for each employee, or for example one bank account for a group of employees, or for example one back account for all the employees, but of course one bank account for each employee is much more preferable as explained above, and preferably the same trustee is used for multiple such accounts, or for example one trustee for each general type of the main occupations, such as for example counselors, teachers, journalists, etc.). Another possible variation is that the self-employed employee can only pull money from his account (for example for salary and/or for his business expenses) by signatures of both himself and someone from the united company, and thus the company has much better control on that. However, these two variations are less preferable since they give the self-employed employee much less feeling of independence. Another possible variation is that the self-employed employee has to give the united company the right to extract automatically the needed amounts every month from this account, in a way similar to paying automatically for example electricity and phone bills. Another possible variation is that the self employed employees can preferably very easily switch from the status of being part of the company to becoming really self employed or being employed in their own private company or switch back, preferably with almost no changes in the other services that are offered by the company, such as for example the automatic accounting services and/or for example the additional benefits described below in clause 4. For example employees that start making a lot of money and don't want to take any risk at all can preferably start having their own company and still automatically get the same or almost all the same services, and/or for example keep even working with the same account except that the account now becomes registered in the bank under the name of the new company, and the united company has no longer any ability to extract money from that account, which is not a problem since in that case the united company is no longer legally or financially responsible for what happens in that account. Preferably if such a person decides later to close his private company and become again an employee in the united company, this can preferably again be done very flexibly with almost no change, so that all the services are again available. Similarly, preferably the company also has the right to require self-employed employees to switch between these states according to various criteria, so that for example people that deal with inherently more risky financial endeavors and/or for example people who have violated various rules of the organization can be required to move into their independent company. Another possible variation is that the company's computer can also automatically recommend to various self-employed employees (without making it a requirement) when it is more preferable for them to have their own company (or become self-employed without a company) and when to be self-employed in the organization, depending on various criteria. Preferably the company's centralized accounting and monitoring preferably automatically checks also that the transactions in each account comply with the receipts that the person filled (This means of course that preferably the company's computers have by agreement with the bank and with the employees direct access to their sub-accounts). Additional details are described below in the reference to FIG. 2. Of course, various combinations of the above and other variations can also be used.

4. Preferably the united company can offer the self-employed employees various additional benefits, such as for example helping them find work and/or deals and/or projects, so that the company acts also for example like a human resources company, except that these are actually self employed people and not normal employees, so it is more like a human resource company for self employed professions. The united company can contact for example large universities and/or colleges and/or hospitals and thus find additional projects for its self-employed employees, and at the same time for example it can find additional employees of these institutions that might want to join the united company. Another possible variation is that the company can offer the self-employed employees various services and/or bonuses based on the size of an organization that unites together for example thousands or tens of thousands or more independent self employed employees, so that for example they can lease cars at much cheaper prices than a normal independent person or small company can get, and/or they can get for example various office supplies at cheaper prices, and/or they can get for example various types of insurance at lower prices, and/or they can be offered for example special offers for shopping various items and/or vacation deals and/or other deals (including for example even real estate deals), etc. Another possible variation is that the company can offer employees for example also investment managing for their accounts for example like in a trust fund, etc. Another possible variation is that the employees can for example buy some unemployment insurance or buy a reduced income insurance from the company, so that for example a certain percent of their monthly income is automatically diverted for example to some trust fund and if their business goes down and they want to quit for a few months or they are making too little money at some period, they can get back a compensating salary from the company itself for a certain period, based for example on how much they put into this insurance and/or on various other criteria, such as for example how stable their income was before, the reasons for the reduction in income etc. Similarly, preferably part of the monthly income of each such employee is used for sickness insurance, vacations, etc. Preferably the optimal amounts for each person are optimized automatically by the company's computer according to his/her income and/or any other relevant criteria and/or considerations. Similarly, preferably a certain percent of the self-employed employee's income each month can be automatically diverted for example to some trust fund, so that if the person leaves the company he can get paid from this fund a discharge compensation. This monthly deposit can be for example exempt from tax. Also, if the person decides for example to rest for a few months or for example his business is down he can quit from the company and thus get for example unemployment fees from the government for a short time, and then join the company again or for example join another similar organization. Of course, preferably the company also does automatically preferably all of the accounting for each person, and preferably gets some constant commission and/or for example some preferably small percent of the person's income for all the services. On the other hand, since for example some self-employed employees might be making too little income that was not previously covered by such insurance, and since they are regarded by the tax authorities as employees of the company, preferably the self-employed employees have to sign a contract with the company that explains the situation of being actually self-employed and exempts the company for example from being required to pay them minimal wages and/or other social obligations, except those that are covered preferably by a certain amount or percent extracted from their income for example on a monthly basis. Another possible variation is that, preferably in addition, the hours that the employee worked each month are computed to be less hours on months where he made an income below the minimal wages. Of course, various combinations of the above and other variations can also be used.

5. Preferably each self-employed employee gets at least a few options and/or stocks of the company, so that he can also take part in its profits and can have more motivation to help it grow further. Also, preferably the self-employed employees have representatives in the board of directors and thus can have at least some control on the company. Also, preferably each self-employed employee that brings to the company additional people who become self-employed employees there gets for example a bonus for that (for example a one-time bonus, or for example a bonus over an extended period, depending for example on the performance or added value of the new employee) and/or gets more options or stock options for that, so that the self employed employees have additional motivation to help the company grow further. Another possible variation is that this can work even recursively, so that for example the person who brings a person that brings an additional person can get for example a smaller commission also for the indirectly added person and so on, for example up to a certain monetary limit and/or up to a certain depth and/or breadth of the resulting sub-tree. Of course, various combinations of the above and other variations can also be used.

Of course, various combinations of the above variations can also be used, for example within the clauses or across them. Of course the company preferably has also normal employees, such as for example secretaries, managers, directors, accountants, lawyers, public relations managers, etc., that help run the company and/or offer various services. Of course, if the self-employed employee had also workers of his/her own (for example before joining the united company), and/or if he/she needs to hire employees after joining the united company, preferably these employees become automatically normal employees of the united company, except that preferably they are listed under the individual cell or department of the self-employed employee and he/she is considered their boss, and preferably the self-employed employee and/or his/her employees have to sign an agreement with the united company that he/she is responsible for paying them minimal wages, and the social benefits required by law, etc. However the united company preferably automatically makes sure that they are given all the social benefits required by law, and if the self-employed employee does not comply with that, the united company can for example use various sanctions against him/her, such as for example keeping a certain amount in his account on hold for covering his/her employees' required social benefits, and/or demanding that he becomes an independent company or independent or leaves the united company if he repeatedly fails to comply with the minimum requirements, etc. Preferably the organization has a strong financial background and reputation so that it gives the self-employed employees a feeling of stability and a pride to be part of it, such as for example a subsidiary of a large bank or of a large financial organization or of a large insurance company or of a large human resources company, etc.

### BRIEF DESCRIPTION OF THE DRAWINGS

FIG. 1 is an illustration of the way an individual invoice/receipt can look like.

FIG. 2 is an illustration of the way the cell structure in the bank can be arranged.

### IMPORTANT CLARIFICATION AND GLOSSARY

All the drawings are just or exemplary drawings. They should not be interpreted as literal positioning, shapes, angles, or sizes of the various elements. Throughout the patent whenever variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. For clarity the user or client or self-employed person has been usually referred to as a male, but it can of course be also for example a female, can be plural or single. Throughout the patent, including the claims, the words “the company” or “the united company” or “the organization” refer to the company under which the self employed persons are united as employees. Throughout the patent, including the claims, the words “self employed employees” mean the persons who can work and/or operate and/or feel like a self employed person while being officially employees of the united company or organization. Throughout the patent, including the claims, the words “computer” or “computers” can mean interchangeably single or plural. Throughout the patent, including the claims, the words “DB” or “database” or “databases” can mean interchangeably single or plural.

### DETAILED DESCRIPTION OF THE PREFERRED EMBODIMENTS

All of descriptions in this and other sections are intended to be illustrative examples and not limiting.

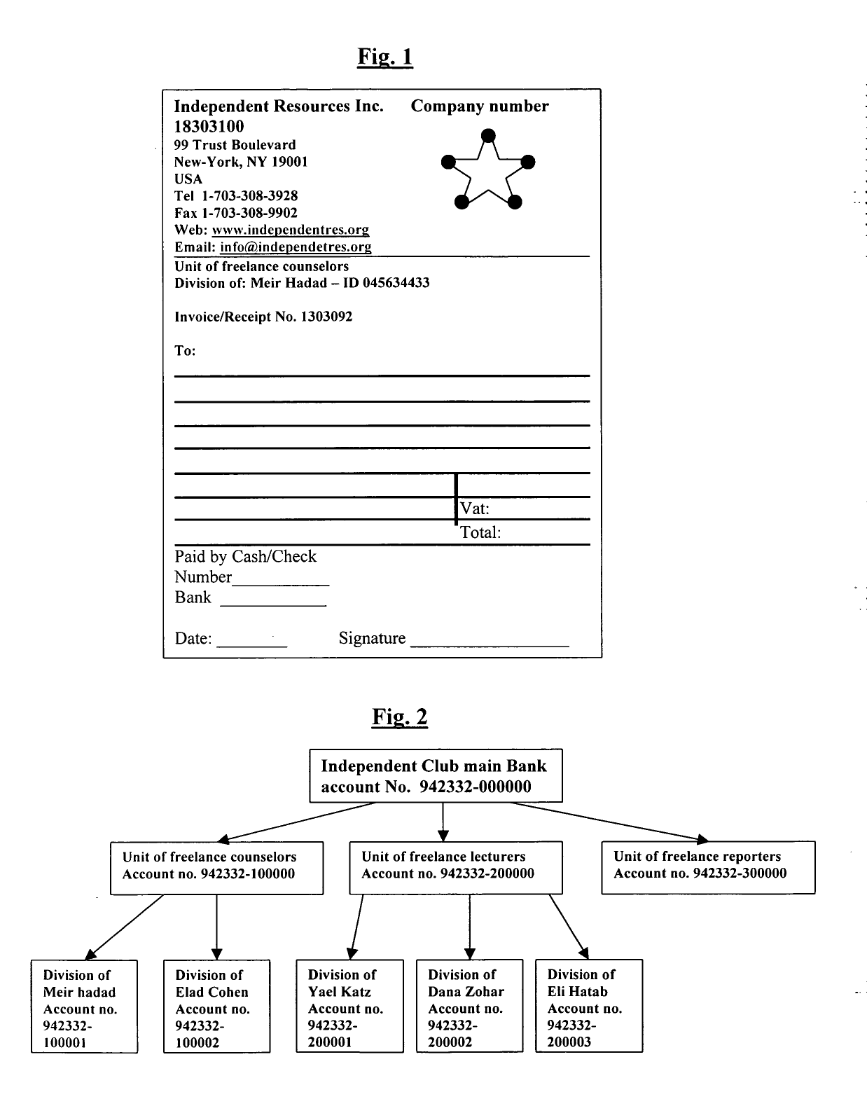

Referring to FIG. 1 we show an illustration of the way an individual invoice/receipt can look like. As can be seen, preferably the Receipt/Invoice carries on top clearly the details and logo of the united company, followed by identifying details of the specific self-employed employee, which preferably include for example at least one of his name, an ID number (which can be for example his citizen Id number or for example a serial number issued by the united company to each self-employed employee), and preferably also a definition of his line of work. The line of work can be defined for example as a unit or division or department in the company, preferably based on 1 or more levels of hierarchy, and the name of the self-employed employee can be for example defined as a department with his name. Of course this is just an example and other variations could also be used, such as for example using the word “department” for other levels of the hierarchy and using the word “division” for referring to the individual unit of the self-employed employee (or for example vice versa). Another possible variation is that for example each invoice or receipt identifies only the type of business or only the details of the self-employed employee but that is less desirable, since identifying only the person does not give any information about his line of business, and letting all self-employed employees of the same line of business have receipts without additional clear separation between them can cause problems of cross-influence of the actions of the employees' on each other, as explained below. Another possible variation is that self-employed employees can also request to have their invoices printed with an additional business name and/or logo (preferably in addition to their name and Id number), for example below the name and logo of the united company, thus creating an even better sense of uniqueness. Preferably each self-employed employee can personally fill and sign his assigned invoices and/or receipts of the united company, without having to depend for example on the company secretary to fill and sign the invoice or receipt for him, except that preferably only the united company has a right to issue such receipts and/or invoices and determine their serial numbers. Since in the eyes of the tax authorities there is only one united company, obviously all receipts and/or invoices need to conform to the logo and identifying details of the company and need to fit with the correct serial numbers, so that different self-employed employees can't get for example the same serial numbers. On the other hand, each receipt preferably has the one or more unique identifiers of the self-employed employee, so that there is a clear differentiation between invoices or receipts issued for different self-employed employees. This is important in order to give the self-employed employee a feeling of control, autonomy and unique identity of his business, so that he is not just an unidentified part of an undefined company. Another advantage is that this way the employees are clearly separated from each other, so that if for example one employee cheats his clients or behaves unfairly to them or tries to cheat the tax authorities, or for example does anything else that could cause bad reputation, this does not effect other employees or the company but only the unique “unit” or cell which is identified with him. Another advantage is that this can help the united company keep track more easily on which invoices were filled by which employees, for example if they get mixed up by mistake. Preferably the company's centralized accounting and monitoring preferably automatically checks also that the transactions in each account comply with the receipts that the person filled. Therefore, preferably the receipts and/or invoices are computerized, and/or each self-employed employee is required for example to scan copies of them into the company's computer and/or key in the relevant details, and preferably these data are sent electronically to the united company. Another possible variation is that the filled numbers in the receipts can be automatically recognized by OCR instead or for example more preferably in addition to the manual keying-in of the values, so that the numbers can be compared to detect possible errors. Similarly, each self-employed employee is preferably required also to scan and/or key-in at least the relevant amounts of money and electronically send the data also for all the receipts of deductible expenses that he acquired each month. On the other hand, since this is considered an unpleasant nuisance by many self employed people, another possible variation is that the invoices and/or receipts issued by the self employed employee and/or all the receipts for deductible expenses acquired by him are simply delivered by him physically (for example personally or by mail) to the united company at least once each month, and for example secretaries or other workers that work for the united company itself take care of keeping copies, preferably issuing a copy of each income and each expense receipt also to the self employed employee, and entering the relevant data into the united company's computer so that preferably the total monthly report to the tax authorities can be completed automatically. This way the self-employed employee gets additional value-added services. Preferably each self-employed employee is required to report all of his expenses and incomes in time before the company has to submit the monthly VAT report to the tax authorities and if he fails to do so, he has to pay the company for example a fine and/or pay back any expenses caused by this to the company for example because of having to pay a fine of not submitting the report on time. If the person for example fails to do it on time too many times and/or for example if the company warns him about improperly filling his invoices and/or receipts and he does not immediately correct it, he can be for example forced by the company to switch to the status of having is own company or becoming self employed (or of course leave the united company altogether if he does not agree to that). (Although letting the self-employed employee fill the receipts himself has some risks if he doesn't fill them properly, not letting him have the receipts and letting only the united company fill the receipt and send it to the third party that gets the service, could lead to bigger problems, since the self-employed might for example report the income and ask the United company to send the receipt to the third party for example a few days or more later or even forget about it, which would be much worth in the eyes of the tax authorities than filling the receipt immediately and making some mistake). Another possible variation is that the self-employed employee is required to fax to the united company a copy of the new receipts and/or invoices that he filled at least once a week or every few days or any other convenient period, so that problems can preferably be discovered almost immediately. Another possible variation is that the company's computers automatically issue a daily report for any money that is entered to the self-employees' sub-accounts, so that there is an additional record for the text authorities for any such income. Preferably the company computers and/or the bank computers also check automatically that there is a reasonable correspondence between the receipts issued and sums deposited in the divisional account of the self employed employee and can for example automatically issue an alert for example if there seem to be unaccounted for incongruities. Of course, various combinations of the above and other solutions can also be used.

Referring to FIG. 2 we show an illustration of the way the cell structure in the bank can be arranged. Preferably, unlike in a normal company, where each employee typically has to make and receive all payments through a common account of the company and wait for example for getting his salary once a month, instead preferably each such employee has his own bank account, which is preferably an independent sub-unit of the company's account. Each self-employed employee's account can for example be a direct sub-account of the main company's account, or a hierarchy of more than 2 levels can be used, so that for example each account is a sub-division of the unit that identifies the type of business of the self-employed employee, such as for example counselors, lecturers, reporters, etc. Although in this example only 3 levels of hierarchy are shown, of course there can be even more levels, so that for example the various fields of business can be further organized in a tree of hierarchy. Preferably the company and the employee have a signed contract with each other and with the bank so that each such employee can deposit and draw his own money from this account like a personal bank account, except that this is preferably regarded as an account of a division of the company that represents the cell associated with that person, and thus not a personal account, and so when the person pulls money out of that account this is regarded as drawing his salary. Preferably the contract also ensures that no other employee has access to his account except for preferably one or more managers of the company who are in charge of monitoring these accounts, and preferably the company can draw money out of the employee's account only under limited conditions, such as for example if he owes the company money for example for required tax advance-payments or for other debts or obligations. Preferably the company is obligated to the self-employed employees that for example in case it becomes bankrupt it cannot touch these accounts, and/or that they are defined for example as an entrusted personal fund. In other words each account is preferably legally separate from accounts of the company itself and/or from accounts of other self employed employees of the company, and preferably of course it is separate from both of the above. The above limitations are extremely important, since otherwise for example employees that make a lot of money and therefore withdraw only a limited salary each months for tax considerations could lose much more than one month's income if the company becomes for example bankrupt for some reason. Another possible variation is that the self employed employees can preferably very easily switch from the status of being part of the company to becoming really self employed or being employed in their own private company or switch back, preferably with almost no changes in the other services that are offered by the company, such as for example the automatic accounting and/or tracking services. For example employees that start making a lot of money and don't want to take any risk at all can preferably start having their own company and still automatically get the same or almost all the same services, and/or for example keep even working with the same account except that the account now becomes registered in the bank under the name of the new company, and the united company has no longer any ability to extract money from that account, which is not a problem since in that case the united company is no longer legally or financially responsible for what happens in that account. Preferably if such a person decides later to close his private company and/or become again an employee in the united company, this can preferably again be done very flexibly with almost no change, so that all the services are again available. Similarly, preferably the company also has the right to require self-employed employees to switch between these states according to various criteria, so that for example people that deal with inherently more risky financial endeavors or for example people who have violated various rules of the organization are required to move into their independent company. Another possible variation is that the company's computer can also automatically recommend to various self-employed employees (without making it a requirement) when it is more preferable for them to have their own company and when to be self-employed in the organization, depending on various criteria. Preferably the company's centralized accounting and monitoring preferably automatically checks also that the transactions in each account comply with the receipts that the person filled, as explained above in the reference to FIG. 1. In addition, preferably each self-employed employee has to sign a contract that allows the united company to instantly remove him or at least force him to work from his own company or become self-employed (or of course leave the united company altogether if he does not agree to that), for example if the company is not satisfied from his activities, for example if they are considered inappropriate and/or illegal in terms of the tax authorities and/or the law and/or unfairness to clients, etc. In addition, preferably each employee has to sign that he alone is responsible for any illegal activities that he does and/or any malpractice and/or has to indemnify the company for any suits brought against the company because of him (including for example professional responsibility and/or malpractice, etc.), so that for example if his clients and/or a third party sues him this does not adversely affect the company. In addition, preferably in the contract with the united company the self-employed employee has to sign an obligation that in any job that he performs for any 3^{rd} party he must explain that he is independent and the united company only gives him certain services and is not responsible for his activities. Another possible variation is that the united company adds automatically to the invoices and receipts and/or other papers that it supplies to the self-employed employee an explanation that he is independent and that the united company only gives him certain services and the united company is not responsible for his activities. In addition, preferably the united company also takes care of insuring the united company itself and the self employed employees for professional responsibility and/or malpractice, and this is preferably automatically deducted from their salary, and preferably failure to pay for that can result in the united company forcing the employee immediately to switch to a status of running his own company or being independent or leaving the united company. On the other hand, since being part of a company means limited liability (unless the persons for example does illegal activities), preferably the self-employed employee can use the protection of the company for example by limiting his normal liability to the amount in the account of his division. Another possible variation is that the cellular structure is further enhanced for example by preferably automatically converting some of the divisions into registered sub-companies (for example daughter companies) of the united company, for example according to general vocation or line of business (for example one daughter company for freelance reporters/journalists, one for lecturers, one for counselors, etc.), and/or for example preferably automatically according to the number of self-employed employees in it, so that for example there is a limited number of employees it each sub-company (However, the accounting and other services are preferably still done centrally by the united company). This can further increase the legal strength of the division. Preferably everything is highly computerized so that for example each self-employed employee is automatically limited by the company's computer as to how much money he can draw out at any time as a salary, so that all the time at least the minimum amount that might be required for paying the company has to remain in the account (this can be implemented for example by automatic lien on that amount or by allowing the company to automatically extract the needed payments for example like when paying bills automatically). Preferably the person can draw out the salary whenever he wants and not just for example once a month, however, preferably whenever the person wants to make such a withdrawal of salary from his company related account, preferably the company's computer tells him for example how much his salary for that month will be considered to be according to the amounts already withdrawn for that month and the amount that he currently intends to withdraw, and the computer can preferably recommend to him each month the recommended amount or range of amounts that can be optimally withdrawn so as to optimize the taxes. For example if the person makes a lot of money that month or during a longer period it might be better to limit the salary, since a company has a lower ceiling for taxes, such as for example 30%-36%, and on the other hand if the person makes a small enough profit it can be better to draw as much as possible as a salary since the tax would be lower than that paid by the company, which can be for example 33% even for a low income. Preferably the person can for example get also a bonus at the end of the year that is not considered a regular salary and thus can further reduce taxes. However, the self-employed employee preferably has to extract the rest of his salary and/or the bonus by the end of the fiscal year, since otherwise he cannot normally carry on surpluses or losses to the next year since it is not his own company. Another possible variation is that for example if someone has losses and/or wishes to carry over surpluses or losses to the next year, this can be preferably settled automatically by the company's computers between the self-employed employee and the company and/or between the various self-employed employees, so that for example the losses of the self-employed employee can help reduce the taxes of the united company and thus the company can pay him some compensation at that time or at a later time, etc. Another possible variation is to reduce the chance of complications for the company for example by limiting membership for example only to lecturers and/or consultants (and/or other vocations that are naturally more fit for such an arrangement, preferably vocations where there is a good monthly turnaround and not many expenses) and/or for example excluding certain areas of activities such as for example imports and or exports, and/or for example allowing people who practice less fit vocations to join only with their own private companies, etc. Another possible variation is that for example each employee gets paid automatically once a month eventhough he has the individual bank account, but that is of course less desirable since that can considerably lower the sense of being indeed independent. Another possible variation is that the self-employed employee can initiate the withdrawal of salary at any time as in the above variations, but if he for example draws a salary below the recommended monthly amount, then the united company's computer can for example warn him about this automatically and/or automatically transfer the missing part of the salary to his individual (non-company) bank account. Of course, various combinations of the above and other variations can also be used.

While the invention has been described with respect to a limited number of embodiments, it will be appreciated that many variations, modifications, expansions and other applications of the invention may be made which are included within the scope of the present invention, as would be obvious to those skilled in the art.

1. A system for enabling self-employed people to work like hired employees in a united company while keeping autonomy, comprising at least one of:
a. A system for issuing for each self-employed employee invoices and/or receipts that contain individual information other than just different serial numbers of the invoice or receipt.
b. A system for issuing and running for each self-employed employee an individual business bank account that is legally separate from other accounts of the company and of other self-employed employees of the company, and the employee draws his salary from said individual account.
c. A system for keeping a cell structure in the united company so that each self-employed employee is protected from at least some actions and/or problems of the company and/or of other self-employed employees.

2. The system of claim 1 wherein the united company runs a separate computerized tracking of all the transactions related to each self-employed employee, and said tracking comprises at least one of:
a. Tracking all the incoming payments associated with the employee, and taking out a commission for the united company based on at least one of a fixed amount and a certain percent of the income.
b. Taking into the account also the deductible expenses of the employee.
c. Printing a periodical report for the employee that includes also his income and his deductible expenses.
d. Taking care of the VAT payments of the employee.
e. Taking care of the National security payments of the employee.
f. Filing the appropriate amounts or percentages out of the person's income for required social security arrangements.
g. Filing the appropriate amounts or percentages out of the person's income for optional social security arrangements which the employee chooses to have.

3. The system of claim 1 wherein at least one of the following features exist:
a. Each self-employed employee can personally fill and sign invoices and/or receipts of the united company.
b. Only the company has a right to issue receipts and/or invoices and determine their serial numbers.
c. All receipts and/or invoices carry the logo and/or identifying details of the company and need to fit with the correct serial numbers, so that different self-employed employees can't get the same serial numbers.
d. The invoices and/or receipts that the self-employed employees can use contain in addition to the name and logo of the united company at least one of: The employee's name, the employee's citizen Id number, a serial number issued by the united company to each employee, a special name for his business which the self-employed employee can choose, and a special logo that the self-employed employee can choose
e. Each self-employed employee is required to scan copies of the receipts and/or invoices that he filled into the company's computer and/or key in the relevant details, and these data are electronically sent to the united company.
f. The filled numbers in the receipts can be automatically recognized by OCR instead or in addition to the manual keying-in of the values, so that the numbers can be compared to detect possible errors.
g. Each self-employed employee is required also to scan and/or key-in at least the relevant amounts of money and electronically send the data also for all the receipts of deductible expenses that he acquired each month.
h. The invoices and/or receipts issued by the self employed employee and/or all the receipts for deductible expenses acquired by him are delivered by him physically to the united company at least one each month, and workers of the united company itself take care of at least one of: Keeping copies, issuing a copy of each income and each expense receipt also to the self employed employee, and entering the relevant data into the united company's computer.
i. Each self-employed employee is required to report all of his expenses and incomes in time before the company has to submit the monthly VAT report to the tax authorities and if he fails to do so, he has to pay the company a fine and/or pay back any expenses caused by this to the company.
j. If the self-employed employee fails to report his incomes and/or expenses on time too many times, he can be forced by the company to switch to the status of having is own company or becoming independent.
k. If the company warns the self-employed employee about improperly filling his invoices and/or receipts and he does not immediately correct it, he can be forced by the company to switch to the status of having is own company or becoming independent.
l. The company computers and/or the bank computers also check automatically that there is a reasonable correspondence between the receipts issued and sums deposited in the divisional account of the self employed.
m. The united company adds automatically to the invoices and receipts and/or other papers that it supplies to the self-employed employee an explanation that said employee is independent and that the united company only gives him certain services and the united company is not responsible for his activities.

4. The system of claim 1 wherein at least one of the following features exist:
a. Each self-employed employee can get paid any times he likes during the month.
b. Each self-employed employee's bank account is a sub-account of the united company's account, with 2 or more levels of hierarchy.
c. The company and the employee have a signed contract with each other and with the bank so that each such employee can deposit and draw his own money from this account like a personal bank account.
d. The account is regarded as an account of a division of the company that represents the cell associated with that person, and thus not a personal account, and so when the person pulls money out of that account this is regarded as drawing his salary.
e. The contract also ensures that no other employee has access to his account except for one or more managers of the company who are in charge of monitoring these accounts.
f. The company can draw money out of the employee's account only under at least one of the following conditions: If he owes the company money for required tax advance-payments and/or for other debts and/or obligations.
g. The company is obligated to the self-employed employees that in case it become bankrupt it cannot touch their accounts.
h. The accounts of the self-employed employees are defined as an entrusted personal fund.
i. The company's centralized accounting and monitoring automatically checks also that the transactions in each account comply with the receipts that the person filled.
j. Each self-employed employee has to sign a contract that allows the united company to instantly remove him or at least force him to work from his own company, if the company is not satisfied from his activities, because they are at least one of: considered inappropriate and/or illegal in terms of the tax authorities and/or the law and/or unfairness to clients.
k. Each self-employed employee has to sign that he alone is responsible for any illegal activities that he does and/or has to indemnify the company for any suits brought against company because of him.
l. In the contract with the united company the self-employed employee has to sign an obligation that in any job that he performs for any 3^{rd} party he must explain that he is independent and the united company only gives him certain services and is not responsible for his activities.
m. The self-employed employee can use the protection of the company for limiting his normal liability to the amount in the account of his division.
n. Each self-employed employee is automatically limited by the united company's computer as to how much money he can draw out at any time as a salary, so that all the time at least the minimum amount that might be required for paying the company has to remain in the account.
o. Whenever the self-employed employee tries to make a withdrawal of salary from his company related account, the company's computer tells him how much his salary for that month will be considered to be according to the amounts already withdrawn for that month and the amount that he currently intends to withdraw, and the computer can recommend to him each month the recommended amount or range of amounts that can be optimally withdrawn so as to optimize the taxes.
p. The self employed employee has to extract the rest of his salary and/or a bonus by the end of the fiscal year, since otherwise he cannot normally carry on surpluses or losses to the next year since it is not his own company.
q. If the self-employed employee has losses and/or wishes to carry over surpluses or losses to the next year, this can be settled automatically by the company's computers between the self-employed employee and the company and/or between the various self-employed employees by method of compensation at the same time or later.
r. The money is in a bank account run by a trustee and the trustee has to authorize each extraction of money by the self employed employee from the account.
s. The self-employed employee can only pull money from his account by signatures of both himself and someone from the united company, and thus the company has much better control on that.
t. The self-employed employee has to give the united company the right to extract automatically the needed amounts every month from this account, in a way similar to paying bills automatically.
u. If the self-employed employee draws a salary below the recommended monthly amount, then the united company's computer can at least one of: Warn him about this automatically and Automatically transfer the missing part of the salary to his individual (non-company) bank account.

5. The system of claim 1 wherein the self employed employees can easily switch from the status of being part of the company to becoming really self employed or to being employed in their own private company or switch back, and at least one of the following features exist:
a. Such switches can be done with almost no changes in the at least one of: The automatic accounting and/or tracking services, and other services that are offered by the company
b. The company also has the right to require self-employed employees to switch between these states according to various criteria, which can include at least one of: People that deal with inherently more risky financial endeavors and/or people who have violated various roles of the organization are required to move into their independent company.
c. The company's computer can automatically recommend to various self-employed employees when it is more preferable for them to have their own company and when to be self-employed in the organization, depending on various criteria.

6. The system of claim 1 wherein the united company can offer the self-employed employees additional benefits based on the fact that a large number of self employed-employees are united together, and said benefits include at least one of:
a. Helping them find work and/or deals and/or projects, so that the company acts also like a human resources company, except that these are actually self employed people and not normal employees,
b. Leasing cars at cheaper prices than a normal independent person or small company can get.
c. Getting office supplies at cheaper prices.
d. Getting various types of insurance at lower prices.
e. Getting special offers for shopping various items and/or vacation deals, and/or other deals.
f. Offering investment managing for their accounts.
g. Offering unemployment insurance or reduced income insurance from the company.
h. Part of the monthly income of each such employee is used for sickness insurance, vacations, etc.
i. A certain percent of the self-employed employee's income each month can be automatically diverted to some trust fund, so that if the person leaves the company he can get paid from this fund a discharge compensation.

7. The system of claim 1 wherein at least one of the following features exists:
a. The self-employed employees have to sign a contract with the company that explains the situation of being actually self-employed and exempts the company from being required to pay them minimal wages and/or other social obligations.
b. Each self-employed employee gets at least a few options and/or stocks of the company, so that he can also take part in its profits and can have more motivation to help it grow further.
c. Each self-employed employee that brings to the company additional people who become self-employed employees there gets at least one of: A bonus for and more options or stock options.

8. The system of claim 7 wherein at least one of the following features exists:
a. The rewards for bringing additional people can work also recursively, so that the person who brings a person that brings an additional person can get a reward also for the indirectly added person.
b. The rewards for bringing additional people can work also recursively, so that the person who brings a person that brings an additional person can get a reward also for the indirectly added person, and this additional recursive rewarding can continue up to a certain monetary limit and/or up to a certain depth and/or breadth of the resulting sub-tree.

9. The system of claim 1 wherein if the self-employed employee needs to employ also his own employees, these employees become automatically normal employees of the united company, except that they are listed under the individual cell or department of the self-employed employee and he/she is considered their boss, and the self-employed employee and/or his/her employees have to sign an agreement with the united company that he/she is responsible for paying them minimal wages, and the social benefits required by law.

10. The system of claim 1 wherein the chance of complications for the company is reduced by at least one of:
a. Limiting membership as employees of the united company only to at least one of: lecturers, consultants, insurance agents, and other vocations that are naturally more fit for such an arrangement.
b. Further enhancing the cellular structure by converting some of the divisions into registered sub-companies of the united company, according to general vocation and/or according to the number of self-employed employees in each division.

11. A method for enabling self-employed people to work like hired employees in a united company while keeping autonomy, based on at least one of the following step:
a. Issuing for each self-employed employee invoices and/or receipts that contain individual information other than just different serial numbers of the invoice or receipt
b. Issuing and running for each self-employed employee an individual business bank account that is legally separate from other accounts of the company and of other self-employed employees of the company, and the employee draws his salary from said individual account.
c. Keeping a cell structure in the united company so that each self-employed employee is protected from at least some actions and/or problems of the company and/or of other self-employed employees.

12. The method of claim 11 wherein the united company runs a separate computerized tracking of all the transactions related to each self-employed employee, and said tracking comprises at least one of:
a. Tracking all the incoming payments associated with the employee, and taking out a commission for the united company based on at least one of a fixed amount and a certain percent of the income.
b. Taking into the account also the deductible expenses of the employee.
c. Printing a periodical report for the employee that includes also his income and his deductible expenses.
d. Taking care of the VAT payments of the employee.
e. Taking care of the National security payments of the employee.
f. Filing the appropriate amounts or percentages out of the person's income for required social security arrangements.
g. Filing the appropriate amounts or percentages out of the person's income for optional social security arrangements which the employee chooses to have.

13. The method of claim 11 wherein at least one of the following features exist:
a. Each self-employed employee can personally fill and sign invoices and/or receipts of the united company.
b. Only the company has a right to issue receipts and/or invoices and determine their serial numbers.
c. All receipts and/or invoices carry the logo and/or identifying details of the company and need to fit with the correct serial numbers, so that different self-employed employees can't get the same serial numbers.
d. The invoices and/or receipts that the self-employed employees can use contain in addition to the name and logo of the united company at least one of: The employee's name, the employee's citizen Id number, a serial number issued by the united company to each employee, a special name for his business which the self-employed employee can choose, and a special logo that the self-employed employee can choose
e. Each self-employed employee is required to scan copies of the receipts and/or invoices that he filled into the company's computer and/or key in the relevant details, and these data are electronically sent to the united company.
f. The filled numbers in the receipts can be automatically recognized by OCR instead or in addition to the manual keying-in of the values, so that the numbers can be compared to detect possible errors.
g. Each self-employed employee is required also to scan and/or key-in at least the relevant amounts of money and electronically send the data also for all the receipts of deductible expenses that he acquired each month.
h. The invoices and/or receipts issued by the self employed employee and/or all the receipts for deductible expenses acquired by him are delivered by him physically to the united company at least one each month, and workers of the united company itself take care of at least one of: Keeping copies, issuing a copy of each income and each expense receipt also to the self employed employee, and entering the relevant data into the united company's computer.
i. Each self-employed employee is required to report all of his expenses and incomes in time before the company has to submit the monthly VAT report to the tax authorities and if he fails to do so, he has to pay the company a fine and/or pay back any expenses caused by this to the company.
j. If the self-employed employee fails to report his incomes and/or expenses on time too many times, he can be forced by the company to switch to the status of having is own company or becoming independent.
k. If the company warns the self-employed employee about improperly filling his invoices and/or receipts and he does not immediately correct it, he can be forced by the company to switch to the status of having is own company or becoming independent.
l. The company computers and/or the bank computers also check automatically that there is a reasonable correspondence between the receipts issued and sums deposited in the divisional account of the self employed.
m. The united company adds automatically to the invoices and receipts and/or other papers that it supplies to the self-employed employee an explanation that said employee is independent and that the united company only gives him certain services and the united company is not responsible for his activities.

14. The method of claim 11 wherein at least one of the following features exist:
a. Each self-employed employee can get paid any times he likes during the month.
b. Each self-employed employee's bank account is a sub-account of the united company's account, with 2 or more levels of hierarchy.
c. The company and the employee have a signed contract with each other and with the bank so that each such employee can deposit and draw his own money from this account like a personal bank account.
d. The account is regarded as an account of a division of the company that represents the cell associated with that person, and thus not a personal account, and so when the person pulls money out of that account this is regarded as drawing his salary.
e. The contract also ensures that no other employee has access to his account except for one or more managers of the company who are in charge of monitoring these accounts.
f. The company can draw money out of the employee's account only under at least one of the following conditions: If he owes the company money for required tax advance-payments and/or for other debts and/or obligations.
g. The company is obligated to the self-employed employees that in case it become bankrupt it cannot touch their accounts
h. The accounts of the self-employed employees are defined as an entrusted personal fund.
i. The company's centralized accounting and monitoring automatically checks also that the transactions in each account comply with the receipts that the person filled.
j. Each self-employed employee has to sign a contract that allows the united company to instantly remove him or at least force him to work from his own company, if the company is not satisfied from his activities, because they are at least one of: considered inappropriate and/or illegal in terms of the tax authorities and/or the law and/or unfairness to clients.
k. Each self-employed employee has to sign that he alone is responsible for any illegal activities that he does and/or has to indemnify the company for any suits brought against company because of him.
l. In the contract with the united company the self-employed employee has to sign an obligation that in any job that he performs for any 3^{rd} party he must explain that he is independent and the united company only gives him certain services and is not responsible for his activities.
m. The self-employed employee can use the protection of the company for limiting his normal liability to the amount in the account of his division.
n. Each self-employed employee is automatically limited by the united company's computer as to how much money he can draw out at any time as a salary, so that all the time at least the minimum amount that might be required for paying the company has to remain in the account.
o. Whenever the self-employed employee tries to make a withdrawal of salary from his company related account, the company's computer tells him how much his salary for that month will be considered to be according to the amounts already withdrawn for that month and the amount that he currently intends to withdraw, and the computer can recommend to him each month the recommended amount or range of amounts that can be optimally withdrawn so as to optimize the taxes.
p. The self employed employee has to extract the rest of his salary and/or a bonus by the end of the fiscal year, since otherwise he cannot normally carry on surpluses or losses to the next year since it is not his own company.
q. If the self-employed employee has losses and/or wishes to carry over surpluses or losses to the next year, this is can be settled automatically by the company's computers between the self-employed employee and the company and/or between the various self-employed employees by method of compensation at the same time or later
r. The money is in a bank account run by a trustee and the trustee has to authorize each extraction of money by the self employed employee from the account.
s. The self-employed employee can only pull money from his account by signatures of both himself and someone from the united company, and thus the company has much better control on that.
t. The self-employed employee has to give the united company the right to extract automatically the needed amounts every month from this account, in a way similar to paying bills automatically.
u. If the self-employed employee draws a salary below the recommended monthly amount, then the united company's computer can at least one of: Warn him about this automatically and Automatically transfer the missing part of the salary to his individual (non-company) bank account.

15. The method of claim 11 wherein the self employed employees can easily switch from the status of being part of the company to becoming really self employed or to being employed in their own private company or switch back, and at least one of the following features exist:
a. Such switches can be done with almost no changes in the at least one of: The automatic accounting and/or tracking services, and other services that are offered by the company
b. The company also has the right to require self-employed employees to switch between these states according to various criteria, which can include at least one of: People that deal with inherently more risky financial endeavors and/or people who have violated various roles of the organization are required to move into their independent company.
c. The company's computer can automatically recommend to various self-employed employees when it is more preferable for them to have their own company and when to be self-employed in the organization, depending on various criteria.

16. The method of claim 11 wherein the united company can offer the self-employed employees additional benefits based on the fact that a large number of self employed-employees are united together, and said benefits include at least one of:
a. Helping them find work and/or deals and/or projects, so that the company acts also like a human resources company, except that these are actually self employed people and not normal employees,
b. Leasing cars at cheaper prices than a normal independent person or small company can get.
c. Getting office supplies at cheaper prices.
d. Getting various types of insurance at lower prices.
e. Getting special offers for shopping various items and/or vacation deals, and/or other deals.
f. Offering investment managing for their accounts.
g. Offering unemployment insurance or reduced income insurance from the company.
h. Part of the monthly income of each such employee is used for sickness insurance, vacations, etc.
i. A certain percent of the self-employed employee's income each month can be automatically diverted to some trust fund, so that if the person leaves the company he can get paid from this fund a discharge compensation.

17. The method of claim 11 wherein at least one of the following features exists:
a. The self-employed employees have to sign a contract with the company that explains the situation of being actually self-employed and exempts the company from being required to pay them minimal wages and/or other social obligations.
b. Each self-employed employee gets at least a few options and/or stocks of the company, so that he can also take part in its profits and can have more motivation to help it grow further.
c. Each self-employed employee that brings to the company additional people who become self-employed employees there gets at least one of: A bonus for and more options or stock options.

18. The method of claim 17 wherein at least one of the following features exists:
a. The rewards for bringing additional people can work also recursively, so that the person who brings a person that brings an additional person can get a reward also for the indirectly added person.
b. The rewards for bringing additional people can work also recursively, so that the person who brings a person that brings an additional person can get a reward also for the indirectly added person, and this additional recursive rewarding can continue up to a certain monetary limit and/or up to a certain depth and/or breadth of the resulting sub-tree.

19. The method of claim 11 wherein if the self-employed employee needs to employ also his own employees, these employees become automatically normal employees of the united company, except that they are listed under the individual cell or department of the self-employed employee and he/she is considered their boss, and the self-employed employee and/or his/her employees have to sign an agreement with the united company that he/she is responsible for paying them minimal wages, and the social benefits required by law.

20. The method of claim 11 wherein the chance of complications for the company is reduced by at least one of:
a. Limiting membership as employees of the united company only to at least one of: lecturers, consultants, insurance agents, and other vocations that are naturally more fit for such an arrangement.
b. Further enhancing the cellular structure by converting some of the divisions into registered sub-companies of the united company, according to general vocation and/or according to the number of self-employed employees in each division.

21. A method in which an insurance company offers insurance agents also accounting services, wherein the normal tracking for the security agents comprises at least one of the following steps:
a. Taking into the account also the deductible expenses of the employee.
b. Taking care of the VAT payments of the employee.
c. Taking care of the National security payments of the employee.
d. Printing a periodical report for the employee that includes also his deductible expenses and not only his incomes.
e. Offering the insurance agents to become self-employed employees of the insurance company.
